(19) United States
(12) Patent Application Publication
(10) Pub. No.: US 2014/0104399 A1
(43) Pub. Date: Apr. 17, 2014

(54) APPARATUS AND METHOD FOR DISPLAYING MULTIVIEW IMAGE AND SUPER MULTIVIEW IMAGE

(71) Applicant: SAMSUNG ELECTRONICS CO., LTD., Suwon-si (KR)

(72) Inventors: Jin Ho LEE, Suwon-si (KR); Dong Kyung Nam, Yongin-si (KR); Ju Yong Park, Seongnam-si (KR)

(73) Assignee: SAMSUNG ELECTRONICS CO., LTD., Suwon-si (KR)

(21) Appl. No.: 13/870,480

(22) Filed: Apr. 25, 2013

(30) Foreign Application Priority Data
Oct. 17, 2012 (KR) 10-2012-0115254

(51) Int. Cl. H04N 13/04

(52) U.S. Cl. CPC H04N 13/0445
USPC 348/51

(57) ABSTRACT

An image display apparatus and method for displaying a multiview image and a super multiview image is provided. The image display apparatus may include a light beam outputting unit to output at least one light beam corresponding to a view image, a diffusion image generating unit to generate a diffusion image by diffuse-projecting the at least one light beam in a predetermined direction, and a multiview image generating unit to display, on a screen, multiview images generated when light beams included in the diffusion image are distributed.

### CROSS-REFERENCE TO RELATED APPLICATIONS

This application claims the priority benefit of Korean Patent Application No. 10-2012-0115254, filed on Oct. 17, 2012, in the Korean Intellectual Property Office, the disclosure of which is incorporated herein by reference.

### BACKGROUND

1. Field

One or more example embodiments relate to an apparatus and method for displaying a multiview image and a super multiview image, and more particularly, to an image display apparatus and method that may increase a number of views of multiview images by adjusting a time division interval of the multiview images and a speed of at least one light beam to be diffuse-projected.

2. Description of the Related Art

Recently, with a propagation of three-dimensional (3D) contents, a stereoscopic 3D television (TV) and an autostereoscopic 3D TV have come into wide use.

The stereoscopic 3D TV provides a 3D image when viewers wear glasses with polarized lenses. Accordingly, the viewers may be inconvenienced by having to wear glasses, and a convergence-accommodation conflict phenomenon may cause visual fatigue.

The autostereoscopic 3D TV provides a 3D image using a lenticular lens, and the like. Here, the autostereoscopic 3D TV may include a multiview display apparatus, and a super multiview display apparatus.

The multiview display apparatus may have a resolution which decreases as a number of views increases. Accordingly, an increase in the number of the views may be limited. Due to a limited number of views or a decreased resolution or both, the multiview display apparatus may be unlikely to provide natural images successively while a viewer is moving. In particular, an image including a discontinuity in a change in a view may be provided, and such discontinuity may cause the viewer dizziness.

The super multiview display apparatus may refer to an apparatus that may increase a number of views by configuring a pitch between views to be less than a distance between eyes. The super multiview display apparatus may need to increase a display resolution to correspond to a number of views.

In this instance, the super multiview display apparatus may fail to deal with a display resolution required as the number of the views increases. Accordingly, the super multiview display apparatus may display a super multiview image, using tens to hundreds of projectors corresponding to micro display apparatuses. Here, a micro display apparatus may include a spatial light modulator (SLM).

However, when multiple projectors are used, a size of the super multiview display apparatus may increase markedly, and power consumption may increase.

### SUMMARY

The foregoing and/or other aspects are achieved by providing an image display apparatus, including a light beam outputting unit to output at least one light beam corresponding to a view image, a diffusion image generating unit to generate a diffusion image by diffuse-projecting the at least one light beam in a predetermined direction, and a multiview image generating unit to display, on a screen, multiview images generated when light beams included in the diffusion image are distributed.

The multiview image generating unit may gather light beams included in the diffusion image in a predetermined direction corresponding to each of the multiview images, using a reflection mirror, and may generate multiview images including the light beams gathered in the predetermined direction.

The reflection mirror may adjust a spatial position pitch between the multiview images to display the multiview images at predetermined view pitches on the screen.

The multiview image generating unit may adjust a view pitch between the multiview images, by adjusting at least one of a diffusing angle of the screen, a curvature of the screen, a curvature of the reflection mirror, and a position of the reflection mirror.

The multiview image generating unit may display multiview images by adjusting the view pitch, wherein the multiview images may represent at least one of a horizontal view and a vertical view.

The screen may include a transmissive diffusing screen or a reflective diffusing screen maintaining a diffusing angle of the light beams included in the diffusion image to be constant.

The diffusion image generating unit may diffuse the at least one light beam in at least one of a horizontal direction, a vertical direction, and a diagonal direction, using a one-dimensionally rotating body or a two-dimensionally rotating body.

The multiview image generating unit may generate super multiview images, by adjusting a time division interval of the multiview images, and a speed of the at least one light beam to be diffuse-projected, and increasing a number of views of the multiview images.

The screen may include a rotary screen provided in a shape of a curved surface, a free curved surface, or a planar surface, and a fixed screen provided in a shape of a sphere, a hemisphere, an ellipse, or a dome.

The foregoing and/or other aspects are achieved by providing an image display apparatus, including a light beam outputting unit to output at least one light beam corresponding to a view image, a diffusion image generating unit to generate a diffusion image by diffuse-projecting the at least one light beam in a predetermined direction, an optical unit to gather light beams included in the diffusion image, and a multiview image generating unit to generate multiview images by distributing the light beams gathered in the predetermined direction.

The optical unit may include at least one of a reflection mirror, and a diffusing screen.

The multiview image generating unit may adjust a view pitch between the multiview images, by adjusting at least one of a diffusing angle of the diffusing screen, a curvature of the diffusing screen, a curvature of the reflection mirror, and a position of the reflection mirror.

The multiview image generating unit may adjust a time division interval of the multiview images by adjusting a switching speed of a spatial light modulator, and may increase a number of views of the multiview images by adjusting a speed of the at least one light beam to be diffuse-projected.

The foregoing and/or other aspects are achieved by providing an image display method, including outputting at least one light beam corresponding to a view image, generating a diffusion image by diffuse-projecting the at least one light beam in a predetermined direction, and displaying, on a screen, multiview images generated when light beams included in the diffusion image are distributed.

The displaying may include gathering light beams included in the diffusion image in a predetermined direction corresponding to each of the multiview images, using a reflection mirror, and generating multiview images including the light beams gathered in the predetermined direction.

The displaying may include adjusting a view pitch between the multiview images, by adjusting at least one of a diffusing angle of the screen, a curvature of the screen, a curvature of the reflection mirror, and a position of the reflection mirror.

The displaying may include displaying multiview images by adjusting the view pitch, wherein the multiview images may represent at least one of a horizontal view and a vertical view.

The screen may include a transmissive diffusing screen or a reflective diffusing screen maintaining a diffusing angle of the light beams included in the diffusion image to be constant.

The generating may include diffusing the at least one light beam in at least one of a horizontal direction, a vertical direction, and a diagonal direction, using a one-dimensionally rotating body or a two-dimensionally rotating body.

The displaying may include generating super multiview images, by adjusting a time division interval of the multiview images, and a speed of the at least one light beam to be diffuse-projected, and increasing a number of views of the multiview images.

The foregoing and/or other aspects are achieved by providing an image display apparatus that includes a light beam outputting unit to output at least one light beam corresponding to a view image, a diffusion image generating unit to generate a diffusion image by diffuse-projecting the at least one light beam in a predetermined direction using a rotating body, and a multiview image generating unit to generate a plurality of multiview images by distributing light beams included in the diffusion image and to display, on the image display apparatus, the plurality of generated multiview images.

The foregoing and/or other aspects are achieved by providing an image display method that includes outputting a plurality of light beams corresponding to a view image, generating a diffusion image by diffuse-projecting the a plurality of light beams in a predetermined direction using a rotating body, generating a plurality of multiview images by distributing light included in the diffusion image, and displaying the plurality of generated multiview images on a display.

The foregoing and/or other aspects are achieved by providing an image display method that includes generating a diffusion image by diffuse-projecting a plurality of received light beams in a predetermined direction using a rotating body, generating a plurality of multiview images by distributing light included in the diffusion image, displaying the plurality of generated multiview images on a screen, and adjusting a view pitch between the plurality of displayed multiview images by adjusting at least one of a diffusing angle of the screen and a curvature of the screen.

The foregoing and/or other aspects are achieved by providing an image display apparatus that includes a light beam outputting unit to output at least one light beam corresponding to a view image, a diffusion image generating unit to generate a diffusion image by diffuse-projecting the at least one light beam in a predetermined direction using a two-dimensionally rotating body, and a multiview image generating unit to generate a plurality of multiview images by distributing light beams included in the diffusion image and to display, on the image display apparatus, the plurality of generated multiview images.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a configuration of a light field display apparatus according to a conventional art;

FIG. 2 illustrates a configuration of an image display apparatus according to example embodiments;

FIG. 3 illustrates an image display apparatus generating a diffusion image using a one-dimensionally rotating body according to example embodiments;

FIG. 4 illustrates an operation of generating multiview images using a diffusing screen, without use of a reflection mirror in the image display apparatus of FIG. 3;

FIG. 5 illustrates an image display apparatus generating a diffusion image using a two-dimensionally rotating body according to example embodiments;

FIG. 6 illustrates an operation of generating multiview images using a diffusing screen, without use of a reflection mirror in the image display apparatus of FIG. 5;

FIG. 7 illustrates an operation of the image display apparatus of FIG. 2 adjusting a horizontal view pitch between multiview images;

FIG. 8 illustrates an operation of the image display apparatus of FIG. 2 adjusting a vertical view pitch between multiview images;

FIG. 9 illustrates an operation of the image display apparatus of FIG. 2 displaying multiview images representing a horizontal view and a vertical view;

FIG. 10 illustrates an image display apparatus displaying multiview images using a rotary screen according to example embodiments;

FIG. 11 illustrates an image display apparatus displaying multiview images using a fixed diffusing screen according to example embodiments;

FIG. 12 illustrates a structure of the image display apparatus of FIG. 11 including an optical unit disposed outside a screen;

FIG. 13 illustrates a structure of the image display apparatus of FIG. 11 including an optical unit disposed inside a screen;

FIG. 14 illustrates an image display apparatus including an optical unit and a rotary diffusing screen provided in a cylindrical shape according to example embodiments;

FIG. 15 illustrates a structure of an image display apparatus including an optical unit and a diffusing screen including a motor according to example embodiments;

FIG. 16 illustrates a structure of an image display apparatus including a fixed diffusing screen provided in a domical shape according to example embodiments;

FIG. 17 illustrates a structure of an image display apparatus including a fixed diffusing screen provided in a spherical shape according to example embodiments; and

FIG. 18 illustrates a method of displaying multiview images in the image display apparatus of FIG. 2.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

According to one or more example embodiments, an image display method may be performed by an image display apparatus.

In addition, the image display apparatus and method may include a multiview display apparatus and method, and a light field display apparatus and method.

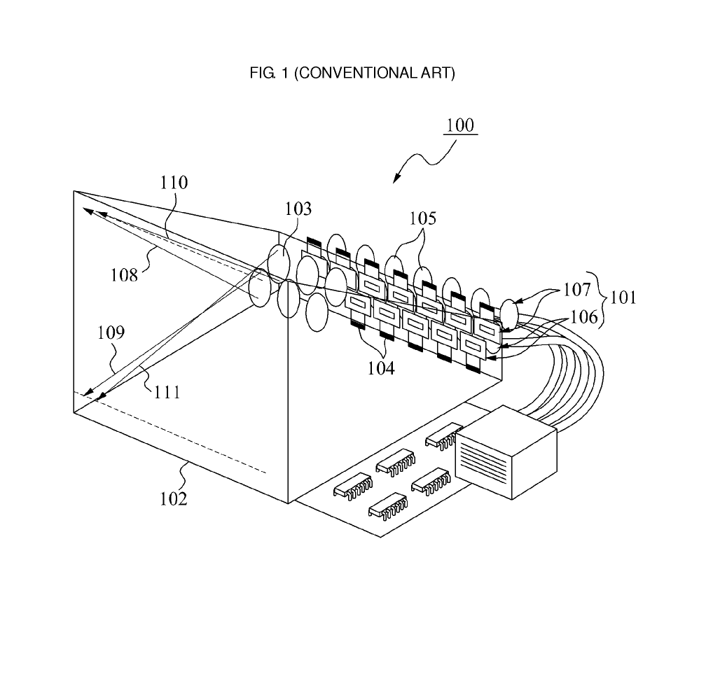

FIG. 1 illustrates a configuration of a light field display apparatus 100 according to a conventional art.

Referring to FIG. 1, the light field display apparatus 100 may include a plurality of optical modules 101, and a screen 102.

The plurality of optical modules 101 may include a plurality of lenses 103, a plurality of micro displays 104, and a plurality of collimators 105 in order to display a plurality of view images in a horizontal direction on the screen 102.

As an example, the plurality of optical modules 101 may be disposed in two rows. In this instance, optical modules disposed in each row may be disposed to be half-shifted. For example, first optical modules 106 disposed in a first row, and second optical modules 107 disposed in a second row may be disposed to be half-shifted so that the first optical modules 106 and the second optical modules 107 may half-overlap.

In this instance, a light beam 108 output by a primary optical module among the first optical modules 106, and a light beam 110 output by a primary optical module among the second optical modules 107 may be displayed at an upper end of the screen 102. A light beam 109 output by the primary optical module among the first optical modules 106, and a light beam 111 output by the primary optical module among the second optical modules 106 may be displayed at a lower end of the screen 102.

When a plurality of optical modules is disposed to be half-shifted, a difference between positions of optical modules disposed in each row may cause a difference in angles between light beams output by the optical modules. In this instance, the difference in angles between the light beams may be corrected, using a screen having a relatively great diffusing angle in a vertical direction.

The light field display apparatus 100 may display a 3D image, by synthesizing directional light beams output by the plurality of optical modules 101. In this instance, the light field display apparatus 100 may increase a number of light beams, thereby increasing a depth resolution of the 3D image. In particular, the light field display apparatus 100 may increase a number of the optical modules 101, thereby increasing a depth resolution of the 3D image.

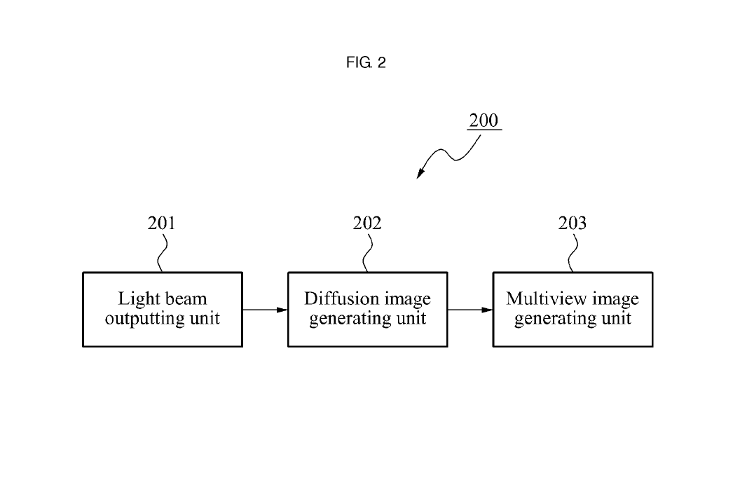

FIG. 2 illustrates a configuration of an image display apparatus 200 according to example embodiments.

Referring to FIG. 2, the image display apparatus 200 may include, for example, a light beam outputting unit 201, a diffusion image generating unit 202, and a multiview image generating unit 203.

The light beam outputting unit 201 may output at least one light beam corresponding to a view image. Here, the light beam outputting unit 201 may correspond to a projector or an optical module corresponding to a micro display including a spatial light modulator (SLM).

For example, the light beam outputting unit 201 may perform a switching control of the SLM at high speed, and may generate a plurality of overlapping view images by receiving image information to be used to generate view images. In particular, the light beam outputting unit 201 may output light beams corresponding to a plurality of overlapping view images to the diffusion image generating unit 202.

The diffusion image generating unit 202 may generate a diffusion image, by diffuse-projecting the at least one light beam output by the light beam outputting unit 201 in a predetermined direction.

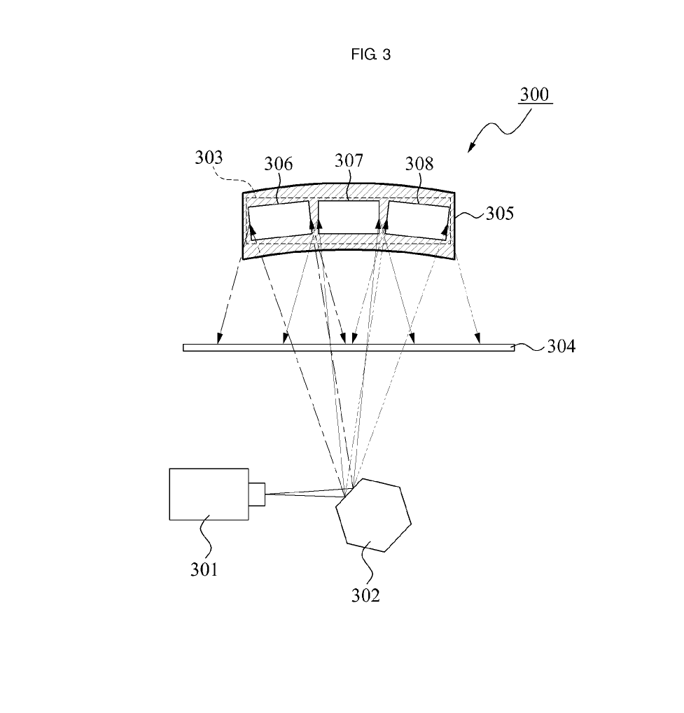

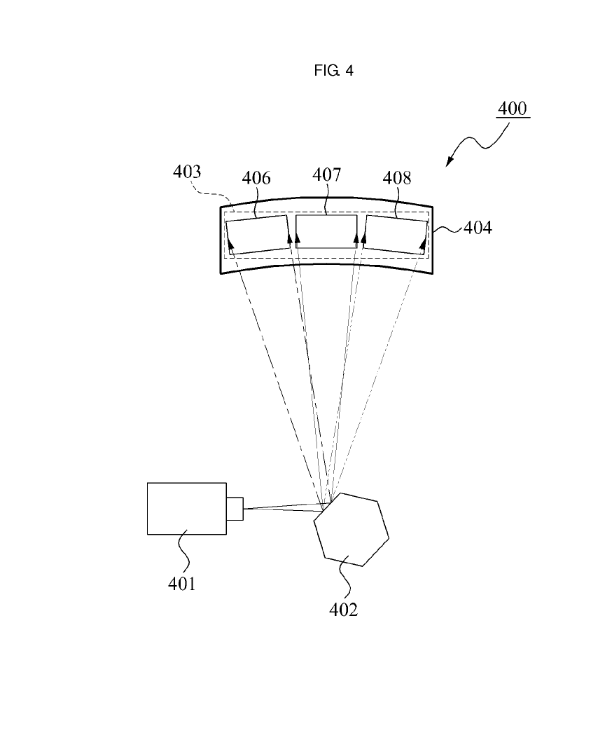

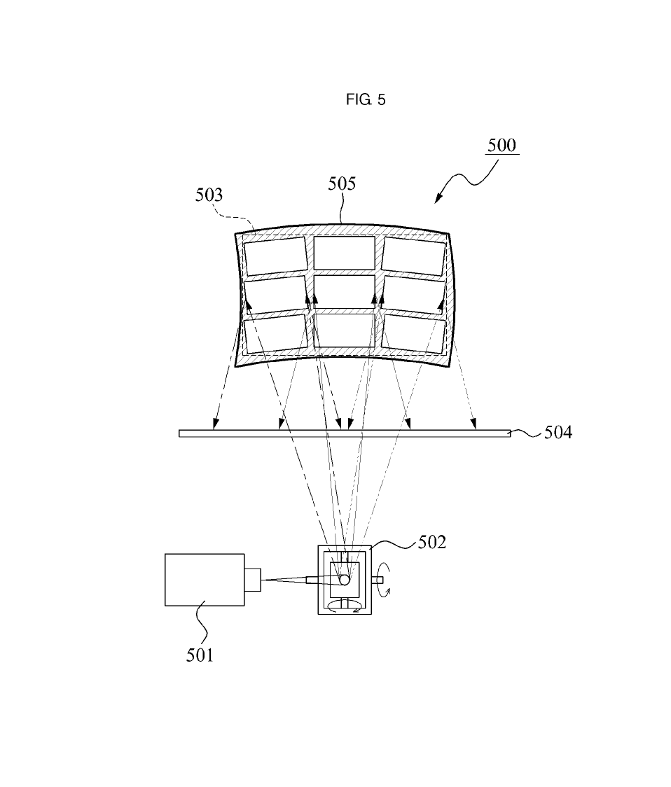

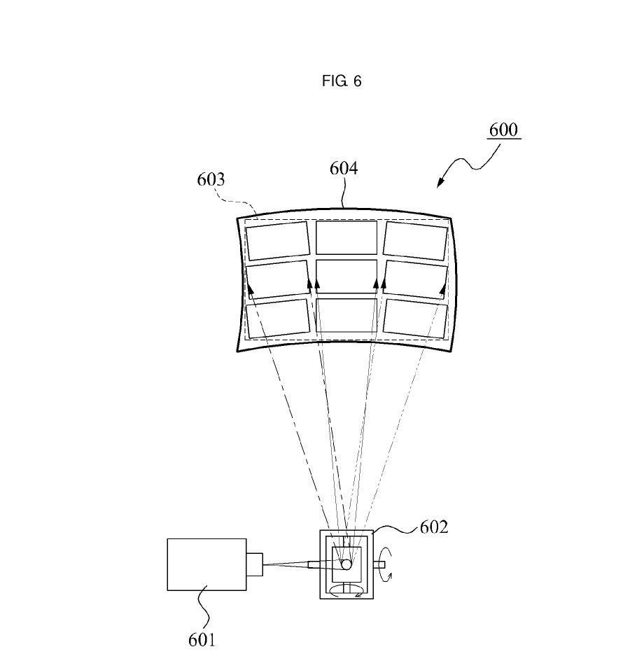

For example, the diffusion image generating unit 202 may diffuse the at least one light beam in at least one of a horizontal direction, a vertical direction, and a diagonal direction, using either a one-dimensionally rotating body or a two-dimensionally rotating body. An operation of generating a diffusion image using the one-dimensionally rotating body will be described in detail with reference to FIGS. 3 and 4 and using the two-dimensionally rotating body will be described in detail with reference to FIGS. 5 and 6.

The multiview image generating unit 203 may display, on a screen, multiview images generated when light beams included in the diffusion image are distributed. Here, a multiview image may correspond to a distributed image.

As an example, the multiview image generating unit 203 may gather the light beams included in the diffusion image in a predetermined direction corresponding to each of the multiview images, using a reflection mirror.

In addition, the multiview image generating unit 203 may generate multiview images including the light beams gathered in the predetermined direction. In this instance, the reflection mirror may gather the light beams in the predetermined direction, thereby adjusting a spatial position pitch between the multiview images. The multiview images in which the spatial position pitch has been adjusted may be displayed to be spaced at a variety of predetermined view pitches on the screen.

When the light beams are gathered in the predetermined direction, the light beams included in the diffusion image may be distributed into light beams included in each of the multiview images, and may be displayed on the screen.

As another example, the multiview image generating unit 203 may generate multiview images, by distributing light beams included in the diffusion image using a diffusing screen directly, without use of the reflection mirror. Here, an operation of generating multiview images using the reflection mirror or the diffusing screen directly will be described in detail with reference to FIGS. 4 and 6.

FIG. 3 illustrates an image display apparatus 300 generating a diffusion image using a one-dimensionally rotating body according to example embodiments.

Referring to FIG. 3, the image display apparatus 300 may include, for example, a light beam outputting unit 301, a diffusion image generating unit 302, a multiview image generating unit 303, a screen 304, and a reflection mirror 305.

The light beam outputting unit 301 may output at least one light beam corresponding to a view image. Here, the light beam outputting unit 301 may correspond to a projector or an optical module.

For example, in an embodiment, the light beam outputting unit 301 may output at least one light beam using a single physical projector.

The diffusion image generating unit 302 may generate a diffusion image, by diffuse-projecting the at least one light beam output by the light beam outputting unit 301 in a predetermined direction.

As an example, the diffusion image generating unit 302 may generate a diffusion image using a one-dimensionally rotating unit capable of rotating in one of a horizontal direction, a vertical direction, and a diagonal direction. Here, the one-dimensionally rotating unit may include a unidirectional rotating body having a reflective surface, for example, a polygonal mirror, a torsional device, a tilting device, a rotating device, and the like, a unidirectional rotating body having a diffusion function corresponding to a reflection, for example, a refraction, a diffraction, and the like, and a unidirectional rotating body having a transmission function.

For example, when a one-dimensionally rotating body rotating in a horizontal direction is used, the diffusion image generating unit 302 may diffuse, in the horizontal direction, at least one light beam entering from the light beam outputting unit 301 while rotating at a predetermined speed.

The multiview image generating unit 303 may generate multiview images by gathering light beams included in the diffusion image in a predetermined direction. In this instance, the multiview image generating unit 303 may generate multiview images by distributing light beams included in the diffusion image, using the reflection mirror 305 or the diffusing screen directly.

As an example, when three multiview images are to be generated using the reflection mirror 305, the multiview image generating unit 303 may gather the light beams included in the diffusion image in a direction corresponding to each of the three multiview images, using the reflection mirror 305, thereby distributing the light beams included in the diffusion image into light beams included in each of the three multiview images. Here, the reflection mirror 305 may be provided in various shapes, for example, a shape of a curved surface, a polygonal shape, a shape of a free curved surface, a shape of a planar surface, and the like.

As another example, when three multiview images are to be generated, the multiview image generating unit 303 may include three virtual projectors. Each of the three virtual projectors may distribute light beams included in the diffusion image so that light beams corresponding to light beams included in a first multiview image, a second multiview image, and a third multiview image generated using the reflection mirror 305 by three physical projectors, respectively, may be included in a first multiview image, a second view image, and a third view image generated by the three virtual projectors, respectively.

Here, positions of the plurality of virtual projectors may correspond to positions of the plurality of physical projectors generating multiview images in a conventional image display apparatus. In addition, the physical projectors may refer to projectors included in the conventional image display apparatus to generate three multiview images.

In particular, the multiview image generating unit 303 may gather, using the reflection mirror 305, light beams corresponding to light beams included in a first multiview image generated by a first physical projector, among the light beams included in the diffusion image, and may generate a first multiview image 306 including the gathered light beams. The multiview image generating unit 303 may gather, using the reflection mirror 305, light beams corresponding to light beams included in a second multiview image generated by a second physical projector, among the light beams included in the diffusion image, and may generate a second multiview image 307 including the gathered light beams. In a similar manner, the multiview image generating unit 303 may gather, using the reflection mirror 305, light beams corresponding to light beams included in a third multiview image generated by a third physical projector, among the light beams included in the diffusion image, and may generate a third multiview image 308 including the gathered light beams.

The multiview image generating unit 303 may display the first multiview image 306, the second multiview image 307, and the third multiview image 308 on the screen 304. Here, the screen 304 may include a transmissive diffusing screen, or a reflective diffusing screen.

In FIG. 3, the multiview image generating unit 303 may adjust a view pitch between multiview images, by adjusting at least one of a curvature of the reflection mirror 305, a position of the reflection mirror 305, a scanning angle of the one-dimensionally rotating body, and a position of the one-dimensionally rotating body.

Here, the view pitch may correspond to a projector pitch. In particular, the multiview image generating unit 303 may adjust at least one of the curvature of the reflection mirror 305, the position of the reflection mirror 305, the scanning angle of the one-dimensionally rotating body, and the position of the one-dimensionally rotating body, thereby adjusting the positions of the plurality of virtual projectors to correspond to the positions of the plurality of physical projectors.

The image display apparatus 300 may generate a plurality of multiview images using a single physical projector, by adjusting at least one of the curvature of the reflection mirror 305, the position of the reflection mirror 305, the scanning angle of the one-dimensionally rotating body, and the position of the one-dimensionally rotating body. For example, the image display apparatus 300 may generate N multiview images using a single physical projector. Accordingly, a number of physical projectors to be used to generate the N multiview images may decrease, whereby a size and a cost of manufacturing the image display apparatus 300 may decrease.

FIG. 4 illustrates an operation of generating multiview images using a diffusing screen curved in various shapes, without use of a reflection mirror in the image display apparatus 300 of FIG. 3.

Referring to FIG. 4, an image display apparatus 400 may include, for example, a light beam outputting unit 401, a diffusion image generating unit 402, a multiview image generating unit 403, and a screen 404, such as a diffusing screen.

The image display apparatus 400 has a structure in which the reflection mirror is excluded from the image display apparatus 300 of FIG. 3 and thus, a repeated description of duplicated elements will be omitted here for conciseness.

Operation of the multiview image generating unit 303 adjusting a view pitch between multiview images, using the reflection mirror 305 is described in the foregoing with reference to FIG. 3.

In this instance, referring to FIG. 4, a multiview image generating unit 403 may adjust a view pitch between multiview images, without use of a reflection mirror.

For example, the multiview image generating unit 403 may adjust the view pitch between the multiview images, by adjusting at least one of a diffusing angle of a diffusing screen, a curvature of the diffusing screen, a scanning angle of a one-dimensionally rotating body, and a position of the one-dimensionally rotating body.

FIG. 5 illustrates an image display apparatus 500 generating a diffusion image using a two-dimensionally rotating body according to example embodiments.

Referring to FIG. 5, the image display apparatus 500 may include, for example, a light beam outputting unit 501, a diffusion image generating unit 502, a multiview image generating unit 503, and a screen 504.

The image display apparatus 500 may differ from the image display apparatus 300 of FIG. 3 in terms of a configuration using a two-dimensionally rotating body to generate a diffusion image. In practice operations of a light beam outputting unit 501, a multiview image generating unit 503, and a screen 504 may be identical to the operations of the light beam outputting unit 301, the multiview image generating unit 303, and the screen 304. Accordingly, a duplicated description will be omitted here for conciseness.

The light beam outputting unit 501 may output at least one light beam corresponding to a view image. Here, the light beam outputting unit 501 may correspond to a projector or an optical module.

The diffusion image generating unit 502 may generate a diffusion image, by diffuse-projecting the at least one light beam output by the light beam outputting unit 501 in a predetermined direction.

As an example, the diffusion image generating unit 502 may generate the diffusion image using a two-dimensionally rotating body capable of rotating in at least two of a horizontal direction, a vertical direction, and a diagonal direction. Here, the two-dimensionally direction may include a bidirectional rotating body having a reflective surface, for example, a torsional device, a tilting device, a rotating device, and the like, a bidirectional rotating body having a diffusion function corresponding to a reflection, for example, a refraction, a diffraction, and the like, and a bidirectional rotating body having a transmission function.

For example, when a two-dimensionally rotating body rotates in a horizontal direction and a vertical direction, the diffusion image generating unit 502 may diffuse, in the horizontal direction and the vertical direction, at least one light beam entering from the light beam outputting unit 501 while rotating in the horizontal direction at a predetermined first speed, and rotating in the vertical direction at a predetermined second speed. Here, the predetermined first speed may be different from or identical to the predetermined second speed.

As another example, the diffusion image generating unit 502 may diffuse the at least one light beam output by the light beam outputting unit 501, in at least two of the horizontal direction, the vertical direction, and the diagonal direction, using two one-dimensionally rotating bodies capable of rotating in a single direction. In this instance, the two one-dimensionally rotating bodies may be disposed transversely to each other.

The multiview image generating unit 503 may generate multiview images by gathering light beams included in the diffusion image in a predetermined direction.

In this instance, the multiview image generating unit 503 may generate multiview images, by distributing the light beams included in the diffusion image using a reflection mirror or a diffusing screen directly. Here, the reflection mirror may be provided in various shapes, for example, a shape of a curved surface, a polygonal shape, a shape of a free curved surface, a shape of a planar surface, and the like.

The multiview image generating unit 503 may display the multiview images on the screen 504. Here, the screen 504 may include a transmissive diffusing screen or a reflective diffusing screen maintaining a diffusing angle of the light beams included in the diffusion image to be constant.

As described with reference to FIG. 5, the image display apparatus 500 may diffuse at least one light beam simultaneously in a horizontal direction and a vertical direction, using a two-dimensionally rotating body. Accordingly, the image display apparatus 500 may display multiview images representing a horizontal disparity and a vertical disparity on the screen 504, using a single physical projector.

FIG. 6 illustrates an operation of generating multiview images using a diffusing screen curved in various shapes, without use of a reflection mirror in the image display apparatus 500 of FIG. 5.

Referring to FIG. 6, an image display apparatus 600 may include, for example, a light beam outputting unit 601, a diffusion image generating unit 602, a multiview image generating unit 603, and a screen 604.

The image display apparatus 600 has a structure in which a reflection mirror is excluded in the image display apparatus 500 and thus, a repeated description of duplicated elements will be omitted here for conciseness.

Operation of the multiview image generating unit 503 adjusting a view pitch between multiview images, using the reflection mirror 505 is described in the foregoing with reference to FIG. 5.

In this instance, referring to FIG. 6, the multiview image generating unit 603 may generate multiview images using the screen 604 directly, without use of a reflection mirror. For example, the screen 604 may include a diffusing screen. Here, the diffusing screen may be provided in various shapes, for example, a shape of a curved surface, a polygonal shape, a shape of a free curved surface, a shape of a planar surface, a spherical shape, a hemispherical shape, an ellipsoidal shape, or a domical shape.

As described with reference to FIGS. 3 through 6, the diffusion image generating unit may generate a diffusion image, by all possible methods of implementing the identical diffusion, using other physical means, for example, an electrical means, a magnetic means, an optical means, and the like. In addition, the diffusion image generating unit may generate a diffusion image, using a mechanical device including a reflective surface, a silicon mirror manufactured using a semiconductor process, a corresponding implementation device, or the like.

In addition, in FIGS. 3 through 6, the reflective diffusing screen or the transmissive diffusing screen may include a rotary diffusing screen provided in a shape of a curved surface, a free curved surface, a planar surface, or a polygon, and a fixed diffusing screen provided in a shape of a cylinder, a dome, a sphere, a hemisphere, or an ellipse. In this instance, when the diffusing screen provided in the shape of the plane surface is used, the image display apparatus may generate multiview images, by correcting an image distortion occurring in a horizontal direction and a vertical direction of the screen. Also, the image display apparatus may display the multiview images on the screen, by adjusting a horizontal view patch and a vertical view patch between the multiview images so that the view patches may be identical on the screen.

The screen may include a lens to adjust a view pitch between multiview images to be denser. As the view pitch becomes denser, resolutions of multiview images displayed on the screen may increase. In particular, a viewer may view clearer multiview images.

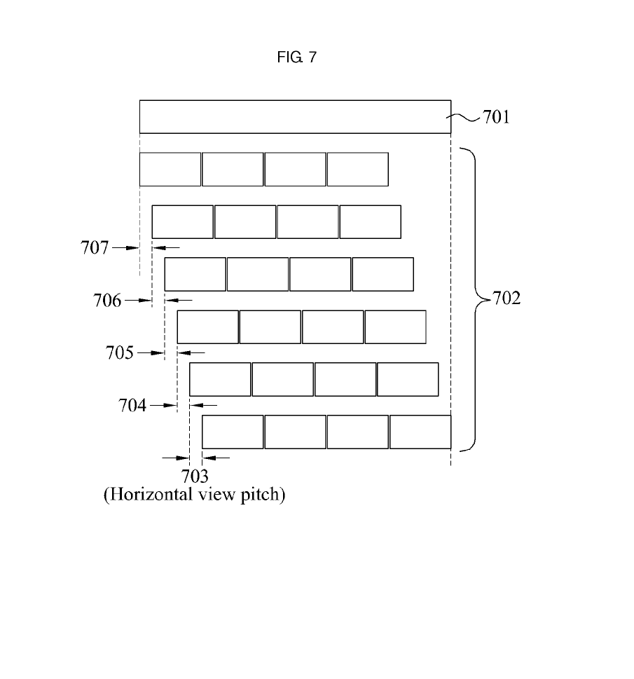

FIG. 7 illustrates an operation of the image display apparatus 200 of FIG. 2 adjusting a horizontal view pitch between multiview images.

In particular, FIG. 7 is provided to describe an operation of adjusting a number of views of multiview images by adjusting a horizontal view pitch so that the number of the views of the multiview images may be identical to a number of target horizontal views.

Referring to FIG. 7, the image display apparatus 200 may generate a diffusion image 701 by diffusing, in a horizontal direction, at least one light beam emitted toward a one-dimensionally rotating body.

As an example, a polygonal mirror having six faces may be used as the one-dimensionally rotating body. In this instance, when the polygonal mirror rotates once, the image display apparatus 200 may generate six diffusion images 702.

In this instance, the image display apparatus 200 may output, to the one-dimensionally rotating body, light beams corresponding to a plurality of view images that is time-divided by adjusting a switching speed of an SLM.

For example, when light beams corresponding to four view images are used, the light beam outputting unit 201 may output, to the one-dimensionally rotating body, light beams corresponding to a first view image at a first time, and light beams corresponding to a second view image at a second time, at a distance of time by adjusting a switching speed of an SLM. Similarly, the light beam outputting unit 201 may output, to the one-dimensionally rotating body, light beams corresponding to a third view image at a third time, and light beams corresponding to a fourth view image at a fourth time.

When the one-dimensionally rotating body rotates once, the one-dimensionally rotating body may generate six diffusion images in which light beams corresponding to the four view images are diffused. In this instance, the multiview image generating unit 203 may generate a total of twenty-four multiview images, by distributing light beams included in each of the six diffusion images in a predetermined direction. In particular, the multiview image generating unit 203 may generate twenty-four multiview images using a single physical projector, identically to a case of generating twenty-four multiview images using twenty-four physical projectors.

In this instance, the one-dimensionally rotating body may diffuse light beams at a relatively great angle so that the multiview images may represent views separated in the screen. For example, the one-dimensionally rotating body may diffuse light beams while moving the light beams in a horizontal direction, a vertical direction, or a diagonal direction at a speed greater than a speed corresponding to a product of a number of target horizontal views of the multiview images and a number of frames.

The multiview image generating unit 203 may generate the multiview images to overlap each other at a distance of time.

For example, when multiview images are to be generated using six diffusion images, the multiview image generating unit 203 may generate multiview images 702 to overlap each other at a difference of time based on a horizontal view pitch. In particular, the multiview image generating unit 203 may generate the multiview images so that a first horizontal view pitch 703, a second horizontal view pitch 704, a third horizontal view pitch 705, a fourth horizontal view pitch 706, and a fifth horizontal view pitch 707 may be identical to one another on the screen. Here, a horizontal view pitch may be defined as a difference in a horizontal position between multiview images of which positions physically overlap each other at a difference of time.

In FIG. 7, the image display apparatus 200 may adjust a time division interval in a horizontal direction of multiview images, by adjusting a switching speed of the SLM. As an example, when the switching speed is adjusted to be fast, the time division interval in the horizontal direction may be adjusted to be narrow. For example, when four multiview images are generated at a first switching speed, six multiview images may be generated at a second switching speed faster than the first switching speed. The image display apparatus 200 may increase a number of views of multiview images by adjusting a time division interval between the multiview images, thereby generating a super multiview image.

In this instance, the image display apparatus 200 may increase the number of the views of the multiview images, by adjusting a speed of at least one light beam to be diffuse-projected. In particular, the image display apparatus 200 may adjust a speed of the one-dimensionally rotating body or the two-dimensionally rotating body, thereby increasing the number of the views of the multiview images so that the number of the views of the multiview images may be identical to a number of target horizontal views.

For example, when a diffusion image is to be generated using the polygon mirror, the image display apparatus 200 may increase a number of views of multiview images, by increasing at least one of a number of rotating surfaces, and a number of rotations of the polygon mirror.

In this instance, the image display apparatus 200 may increase the number of the views of the multiview images, by adjusting both the time division interval in the horizontal direction of the multiview images, and the speed of the at least one light beam to be diffuse-projected.

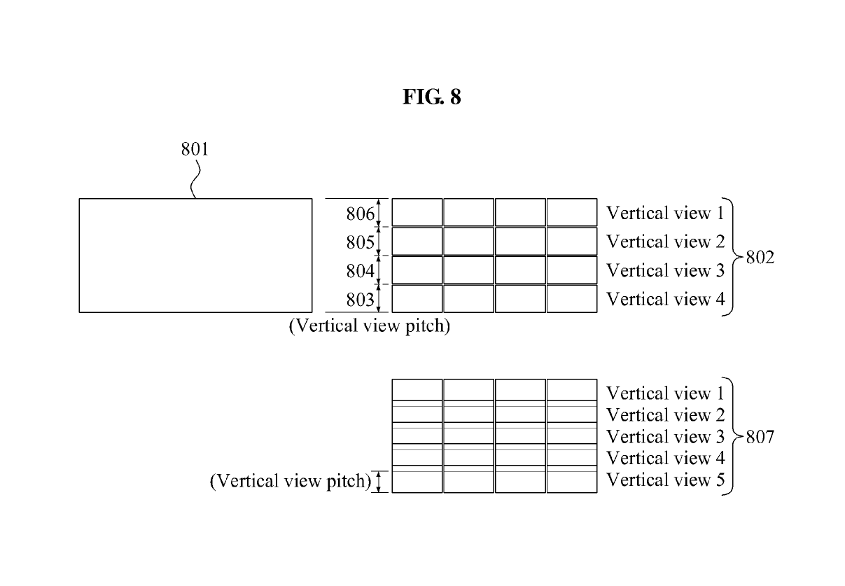

FIG. 8 illustrates an operation of the image display apparatus 200 of FIG. 2 adjusting a vertical view pitch between multiview images.

In particular, FIG. 8 is provided to describe an operation of adjusting a number of views of multiview images by adjusting a vertical view pitch so that the number of the views of the multiview images may be identical to a number of target vertical views. Here, the number of the target vertical views may include a number of views of multiview images in a vertical direction to be provided to a viewer by displaying the multiview images on a screen.

Referring to FIG. 8, the image display apparatus 200 may generate a diffusion image 801 by diffusing, in a horizontal direction and a vertical direction, at least one light beam emitted toward a two-dimensionally rotating body.

As an example, the image display apparatus 200 may generate multiview images representing four vertical views 802 in the vertical direction, by distributing light beams included in the diffusion image 801. For example, the image display apparatus 200 may generate the multiview image to overlap or to be successive in the vertical direction based on a vertical view pitch. In particular, the image display apparatus 200 may generate the multiview images so that a first vertical view pitch 803, a second vertical view pitch 804, a third vertical view pitch 805, and a fourth vertical view pitch 806 may be identical on the screen. Here, a vertical view pitch may be defined as a difference in a vertical position between multiview images of which positions physically overlap or are successive.

In this instance, the image display apparatus 200 may adjust a vertical view pitch between multiview images to be narrow or to be great, by adjusting at least one of a time division interval of the multiview images and a speed of at least one light beam to be diffuse-projected. The image display apparatus 200 may increase or decrease a number of views of the multiview images, by adjusting the vertical view pitch. In this instance, the image display apparatus 200 may generate a super multiview image, by increasing the number of the views of the multiview images.

As an example, the image display apparatus 200 may adjust the time division interval in the vertical direction between the multiview images to be narrow, by adjusting a switching speed of an SLM to be fast. In this instance, the image display apparatus 200 may adjust the time division interval in the vertical direction so that the number of the views of the multiview images may be identical to a number of target vertical views.

As another example, the image display apparatus 200 may adjust a number of views of multiview images, by adjusting a speed of the two-dimensionally rotating body. In this instance, the image display apparatus 200 may adjust the number of the views of the multiview images, by adjusting a vertical speed or a horizontal speed, and the vertical speed of the two-dimensionally rotating body.

For example, when a tilting mirror is used as the two-dimensionally rotating body, the image display apparatus 200 may adjust a vertical speed of the tilting mirror to be fast, thereby increasing a number of views of multiview images so that the number of the views of the multiview images may be identical to a number of target vertical views.

As still another example, the image display apparatus 200 may adjust a number of views of multiview images, by adjusting both the time division interval in the vertical direction between the multiview images, and the vertical speed of the two-dimensionally rotating body. In this example, the image display apparatus 200 may adjust the time division interval in the vertical direction to be narrow, and adjust the vertical speed of the two-dimensionally rotating body to be fast, thereby increasing the number of the views of the multiview images.

Further to this example, the image display apparatus 200 may adjust both the time division interval in the vertical direction between the multiview images, and the vertical speed of the two-dimensionally rotating body, thereby increasing a number of views of multiview images representing the four vertical views 802 so that five vertical views 807 may be represented.

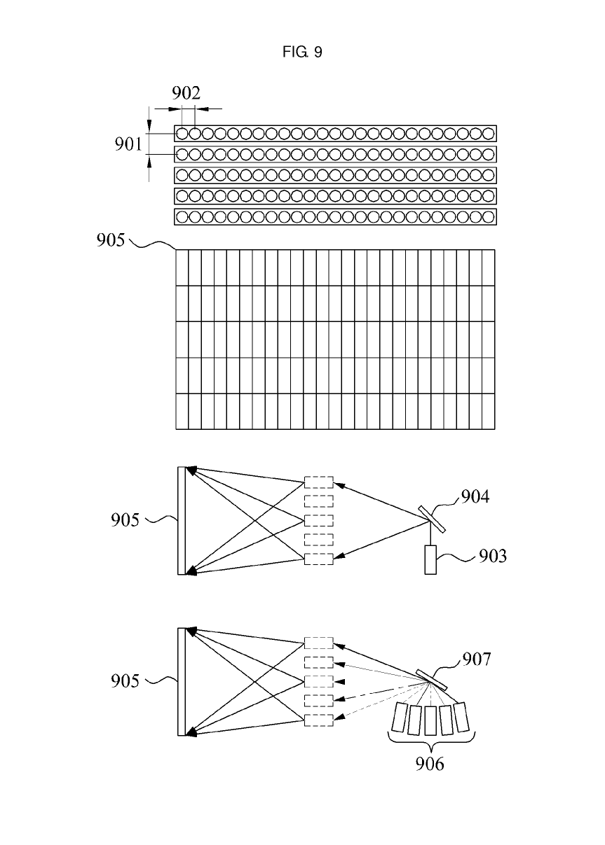

FIG. 9 illustrates an operation of the image display apparatus 200 of FIG. 2 displaying multiview images representing a horizontal view and a vertical view.

Referring to FIG. 9, the image display apparatus 200 may generate a diffusion image, by diffusing, in a horizontal direction and a vertical direction, at least one light beam emitted toward a two-dimensionally rotating body.

The image display apparatus 200 may generate multiview images representing both a horizontal view and a vertical view, by distributing light beams included in the diffusion image using a reflection mirror or a diffusing screen directly. For example, the image display apparatus 200 may generate the multiview images, by distributing the light beams so that the multiview images may overlap or may be successive in a horizontal direction based on a horizontal view pitch 902, and the multiview images may overlap or may be successive in a vertical direction based on a vertical view pitch 901.

As an example, the image display apparatus 200 may generate a diffusion image, by diffusing, in a vertical direction and a horizontal direction, at least one light beam output by a single projector 903, using a two-dimensionally rotating body 904. The image display apparatus 200 may distribute light beams include in the diffusion image, by adjusting at least one of a diffusing angle of a screen 905, and a curvature of the screen 905. The image display apparatus 200 may generate multiview images representing a horizontal view and a vertical view. For example, the image display apparatus 200 may generate multiview images representing five vertical views and twenty-five horizontal views.

As another example, the image display apparatus 200 may display multiview images on the screen 905, using a plurality of projectors 906 disposed in parallel. In this instance, the plurality of projectors 906 may be disposed in parallel, based on a switching speed of an SLM, and a number of views of multiview images to be displayed on a screen.

In particular, the image display apparatus 200 may diffuse, in a vertical direction and a horizontal direction, at least one light beam output by each of the plurality of projectors 906, using a one-dimensionally rotating body 907.

For example, when five physical projectors are disposed in parallel, the image display apparatus 200 may generate a first diffusion image by diffuse-projecting at least one light beam output by a first projector in a vertical direction and a horizontal direction, and may generate a second diffusion image by diffuse-projecting at least one light beam output by a second projector in a vertical direction and a horizontal direction. Similarly, the image display apparatus may generate a third diffusion image, a fourth diffusion image, and a fifth diffusion image.

The image display apparatus 200 may generate multiview images representing a horizontal view and a vertical view, by distributing light beams included in the five diffusion images for each diffusion image. For example, the image display apparatus 200 may generate multiview images representing five vertical views and twenty-five horizontal views. The screen 905 may be divided into five areas in a vertical direction, and twenty-five areas in a horizontal direction. The multiview images representing the five vertical views and the twenty-five horizontal views may be displayed on the screen 905.

The image display apparatus 200 may display multiview images representing both a horizontal view and a vertical direction, using a single physical projector or a plurality of physical projectors. When an eye of the viewer is moved in a vertical direction or a horizontal direction, different multiview images corresponding to the vertical or horizontal movement of the eye may be displayed naturally on the screen by the image display apparatus 200.

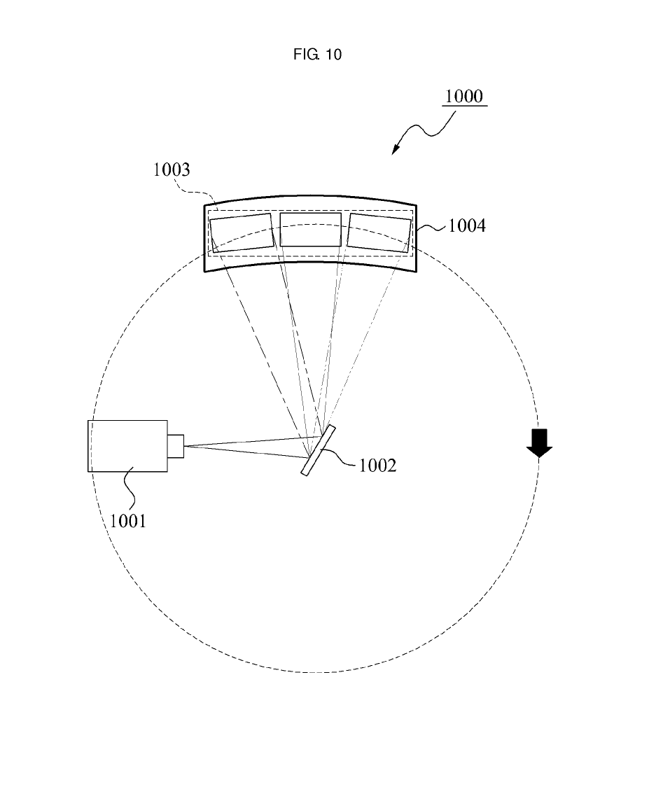

FIG. 10 illustrates an image display apparatus 1000 displaying multiview images using a rotary screen according to example embodiments.

Referring to FIG. 10, the image display apparatus 1000 may include, for example, a light beam outputting unit 1001, a diffusion image generating unit 1002, a multiview image generating unit 1003, and a screen 1004. In FIG. 10, operations of the light beam outputting unit 1001, the diffusion image generating unit 1002, and the multiview image generating unit 1003 are substantially identical to the operations of the light beam outputting unit 201, the diffusion image generating unit 202, and the multiview image generating unit 203 of FIG. 2 and thus, a detailed description will be omitted here for conciseness.

The light beam outputting unit 1001 may output at least one light beam corresponding to a view image. Here, the light beam outputting unit 1001 may correspond to a projector or an optical module.

The diffusion image generating unit 1002 may generate a diffusion image, by diffuse-projecting the at least one light beam output by the light beam outputting unit 1001 in a predetermined direction.

As an example, the diffusion image generating unit 1002 may diffuse at least one light beam, using a one-dimensionally rotating body or a two-dimensionally rotating body. For example, the diffusion image generating unit 1002 may diffuse the at least one light beam in at least one or two of a horizontal direction, a vertical direction, and a diagonal direction.

In this instance, the diffusion image generating unit 1002 may generate a diffusion image on the screen 1004. Here, the screen 1004 may include a reflective diffusing screen or a transmissive diffusing screen. The reflective diffusing screen or the transmissive diffusing screen may include a rotary diffusing screen provided in a shape of a curved surface, a free curved surface, a planar surface, or a polygon, and a fixed diffusing screen provided in a shape of a cylinder, a dome, a sphere, a hemisphere, or an ellipse.

The multiview image generating unit 1003 may generate multiview images by gathering light beams included in the diffusion image in a predetermined direction. For example, the multiview image generating unit 1003 may generate the multiview images, by distributing the light beams included in the diffusion image using a diffusing screen. The multiview image generating unit 1003 may display, on the screen 1004, multiview images having an identical view pitch. In particular, the multiview image generating unit 1003 may display the multiview images on the screen, by adjusting a horizontal view pitch between the multiview images and a vertical view pitch between the multiview images to be uniform.

In this instance, when the rotary screen is used, the screen 1004 may include a motor (not shown). Here, the motor may enable the screen 1004 to rotate 360 degrees, whereby a viewer may be provided with a 360-degree view of multiview images to be displayed on the rotary screen.

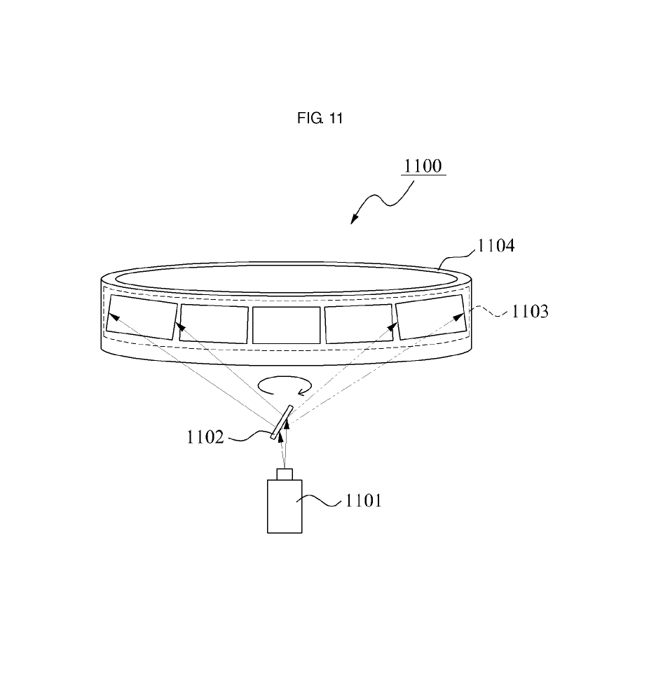

Although the operation of displaying the multiview images on the rotary screen using the motor has been described with reference to FIG. 10, the screen may provide a 360-degree viewing area, without use of the motor. Here, an operation of providing the 360-degree viewing area, without use of the motor will be described in detail with reference to FIG. 11.

FIG. 11 illustrates an image display apparatus 1100 displaying multiview images using a fixed diffusing screen according to example embodiments.

Referring to FIG. 11, the image display apparatus 1100 may include, for example, a light beam outputting unit 1101, a diffusion image generating unit 1102, a multiview image generating unit 1103, and a screen 1104.

In FIG. 11, operations of the light beam outputting unit 1101, the diffusion image generating unit 1102, and the multiview image generating unit 1103 are substantially identical to the operations of the light beam outputting unit 201, the diffusion image generating unit 202, and the multiview image generating unit 203 of FIG. 2 and thus, a detailed description will be omitted here for conciseness.

The light beam outputting unit 1101 may output at least one light beam corresponding to a view image. Here, the light beam outputting unit 1101 may correspond to a projector or an optical module.

The diffusion image generating unit 1102 may generate a diffusion image, by diffuse-projecting the at least one light beam output by the light beam outputting unit 1101 in a predetermined direction.

As an example, the diffusion image generating unit 1102 may diffuse at least one light beam, using a one-dimensionally rotating body or a two-dimensionally rotating body. For example, the diffusion image generating unit 1102 may diffuse the at least one light beam in at least one or two of a horizontal direction, a vertical direction, and a diagonal direction.

In this instance, the diffusion image generating unit 1102 may generate a diffusion image on the screen 1104. Here, the screen 1104 may include a reflective diffusing screen or a transmissive diffusing screen. The reflective diffusing screen or the transmissive diffusing screen may include a rotary diffusing screen provided in a shape of a curved surface, a free curved surface, a planar surface, or a polygon, and a fixed diffusing screen provided in a shape of a cylinder, a dome, a sphere, a hemisphere, or an ellipse. In this instance, the screen provided in the shape of the free curved surface may refer to a screen having an uneven or curved surface.

The multiview image generating unit 1103 may generate multiview images by gathering light beams included in the diffusion image in a predetermined direction. For example, the multiview image generating unit 1103 may generate the multiview images, by distributing the light beams included in the diffusion image using a diffusing screen.

In this instance, when the screen 1104 includes the fixed diffusing screen provided in the cylindrical shape, multiview images having an identical view pitch may be displayed on the screen 1104 by the multiview image generating unit 1103 may display, whereby a viewer may enjoy a 360-degree view of multiview images to be displayed on the screen 1104.

Although an example of using the fixed diffusing screen provided in the cylindrical shape to provide the 360-degree view of the multiview images has been described with reference to FIG. 11, the image display apparatus 1100 may also provide the viewer with the 360-degree view of the multiview images, using a fixed diffusing screen provided in a shape of a cone, or a funnel.

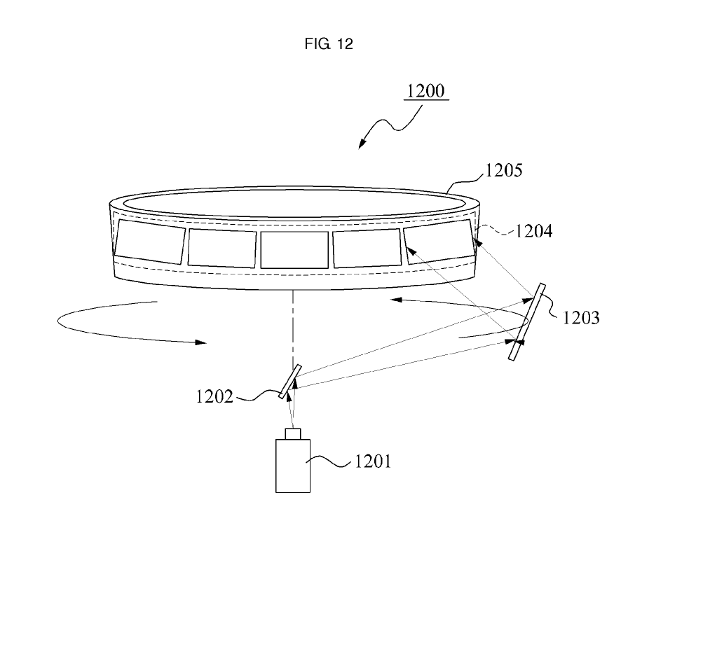

FIG. 12 illustrates a structure of the image display apparatus 1100 of FIG. 11 including an optical unit disposed outside a screen.

Referring to FIG. 12, an image display apparatus 1200 may include, for example, a light beam outputting unit 1201, a diffusion image generating unit 1202, an optical unit 1203, a multiview image generating unit 1204, and a screen 1205.

In FIG. 12, the image display apparatus 1200 has a structure in which the optical unit 1203 is added to the image display apparatus 1100 of FIG. 11 and thus, a duplicated description will be omitted here for conciseness.

The light beam outputting unit 1201 may output at least one light beam corresponding to a view image. Here, the light beam outputting unit 1201 may correspond to a projector or an optical module.

The diffusion image generating unit 1202 may generate a diffusion image, by diffuse-projecting the at least one light beam output by the light beam outputting unit 1201 in a predetermined direction.

As an example, the diffusion image generating unit 1202 may diffuse at least one light beam, using a one-dimensionally rotating body or a two-dimensionally rotating body. For example, the diffusion image generating unit 1202 may diffuse the at least one light beam in at least one or two of a horizontal direction, a vertical direction, and a diagonal direction.

In this instance, the optical unit 1203 may reflect light beams included in the diffusion image generated by the diffusion image generating unit 1202 to the screen 1205, thereby gathering the light beams in a predetermined direction. For example, the optical unit 1203 may include a reflection mirror. The reflection mirror may be disposed outside the screen 1205. The reflection mirror may rotate 360 degrees along an outer edge of the screen 1205. Here, the reflection mirror may be provided in various shapes, for example, a shape of a curved surface, a polygonal shape, a shape of free curved surface, a shape of a planar surface, and the like.

The multiview image generating unit 1204 may display, on the screen 1205, multiview images including the light beams gathered in the predetermined direction, through interworking of the diffusion image generating unit 1202 and the optical unit 1203.

In this instance, the multiview image generating unit 1204 may display the multiview images to have a uniform view pitch on the screen 1205. As an example, the multiview image generating unit 1204 may adjust a view pitch between the multiview images to be uniform on the screen 1205, by adjusting at least one of a diffusing angle of the screen 1205, a curvature of the screen 1205, a curvature of the reflection mirror, and a position of the reflection mirror.

For example, when the screen 1205 includes a fixed diffusing screen provided in a cylindrical shape, the multiview image generating unit 1204 may display multiview images at uniform pitches on the entire 360-degree curved surface of the fixed diffusing screen.

In this instance, the multiview image generating unit 1204 may display the multiview images at uniform pitches in a horizontal direction, based on a horizontal view pitch, and may display the multiview images at uniform pitches in a vertical direction, based on a vertical view pitch. Here, the horizontal view pitch may be identical to or different from the vertical view pitch.

In FIG. 12, the multiview image generating unit 1204 may adjust a time division interval of the multiview images by adjusting a switching speed of an SLM, and may adjust a speed of the at least one light beam output by the light beam outputting unit 1201, thereby increasing a number of views of the multiview images. The multiview image generating unit 1204 may generate a super multiview image by increasing the number of the views of the multiview images.

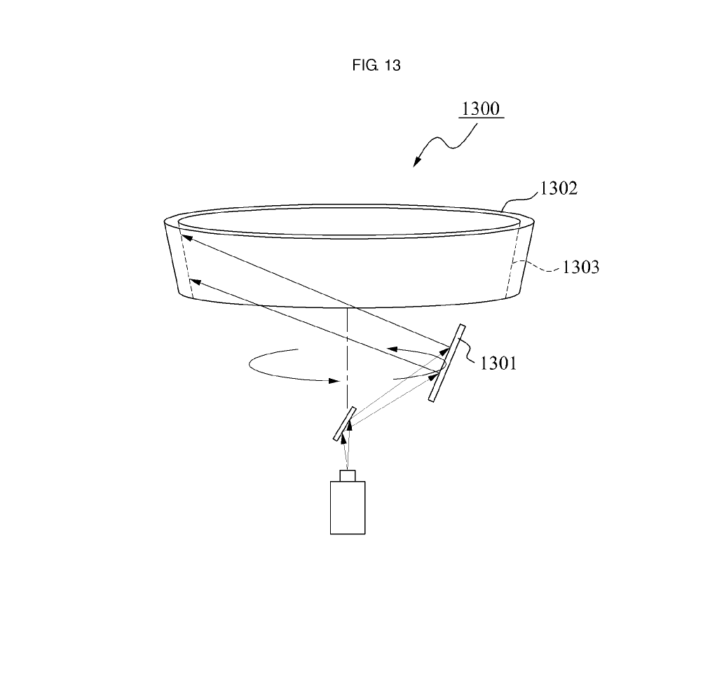

FIG. 13 illustrates a structure of the image display apparatus 1100 of FIG. 11 including an optical unit disposed inside a screen.

In FIG. 13, an image display apparatus 1300 has a structure in which the optical unit 1203 of FIG. 12 is disposed inside the screen and thus, a duplicated description will be omitted here for conciseness.

An optical unit 1301 may reflect light beams included in a diffusion image to a screen 1302, thereby gathering the light beams in a predetermined direction.

As an example, the optical unit 1301 may include a reflection mirror. The reflection mirror may be disposed inside the screen 1302. Here, the screen may include a fixed diffusing screen provided in a cylindrical shape. For example, the optical unit 1301 may rotate 360 degrees along an outer edge of the fixed diffusing screen provided in the cylindrical shape.

When the reflection mirror is disposed inside the screen 1302, the reflection mirror may rotate in a circular path having a radius smaller than the screen 1302. For example, the reflection mirror may be disposed in an area in which a rotation is possible, within an outermost edge 1303 of the screen 1302, among internal areas of the screen 1302. In this instance, the reflection mirror may be provided in various shapes, for example, a shape of a curved surface, a polygonal shape, a shape of a free curved surface, a shape of a planar surface, and the like.

Although the operation of displaying the multiview images on the fixed screen provided in the cylindrical shape, using the reflection mirror, has been described with reference to FIGS. 12 and 13, the diffusing screen provided in the cylindrical shape may be rotatable.

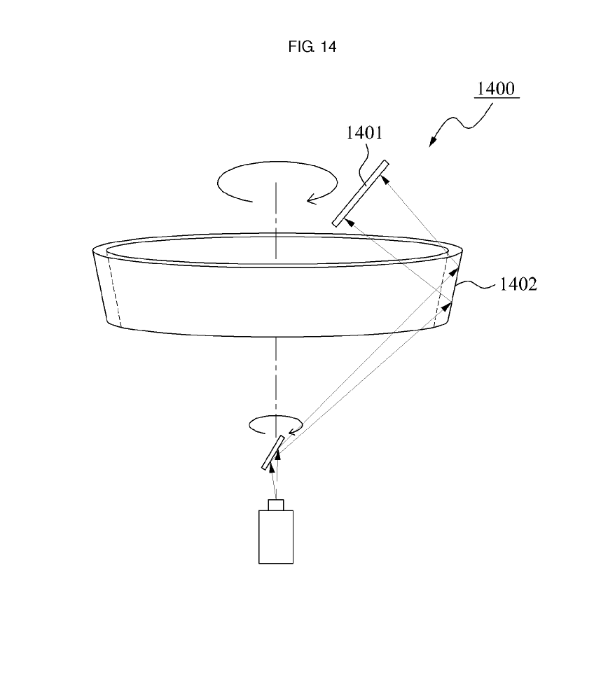

FIG. 14 illustrates an image display apparatus 1400 including an optical unit and a rotary diffusing screen provided in a cylindrical shape according to example embodiments.

Referring to FIG. 14, the image display apparatus 1400 may gather light beams included in a diffusion image in a predetermined direction, using an optical unit 1402 disposed to rotate 360 degrees. The image display apparatus 1400 may display, on a rotary screen 1401, multiview images generated when the light beams gathered in the predetermined direction are distributed. Here, the screen 1401 may include a reflective diffusing screen or a transmissive diffusing screen. In addition, the screen 1401 may be provided in various shapes, for example, a shape of a curved surface, a shape of a free curved surface, a shape of a planar surface, a polygonal shape, and the like.

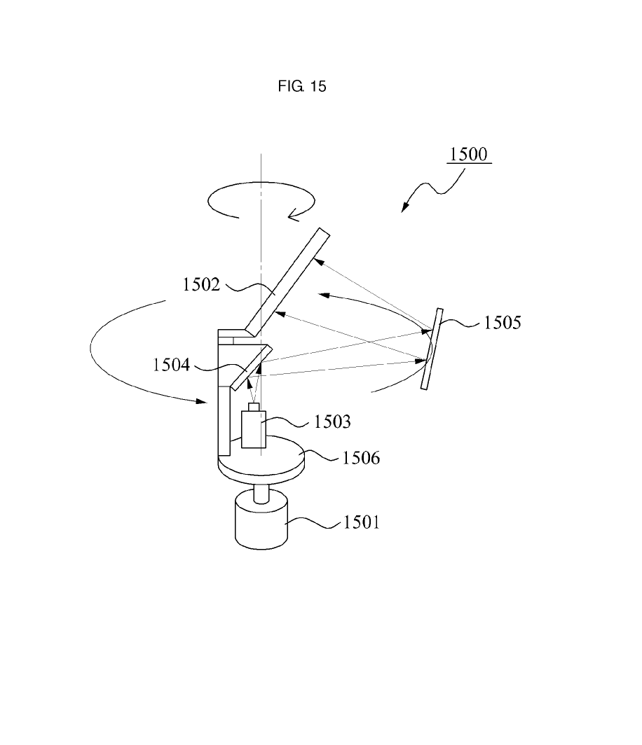

FIG. 15 illustrates a structure of an image display apparatus 1500 including an optical unit and a diffusing screen including a motor according to example embodiments.

Referring to FIG. 15, the image display apparatus 1500 may rotate a screen 1502, 360 degrees, using a motor 1501. In this instance, a light beam outputting unit 1503, a diffusion image generating unit 1504, and an optical unit 1505 may be coupled into one using a tool 1506. The motor may be disposed at a bottom end of the tool 1506.

Here, the screen 1502 may include a reflective diffusing screen or a transmissive diffusing screen. In addition, the screen 1502 may be provided in various shapes, for example, a shape of a curved surface, a shape of a free curved surface, a shape of a planar surface, a polygonal shape, and the like.

In this instance, the diffusion image generating unit 1504 and the optical unit 1505 may rotate 360 degrees. For example, the optical unit 1505 may rotate 360 degrees about the diffusion image generating unit 1504, along an outer edge of the diffusion image generating unit 1504. Here, a reflection mirror may be provided in various shapes, for example, a shape of a curved surface, a polygonal shape, a shape of a free curved surface, a shape of a planar surface, and the like.

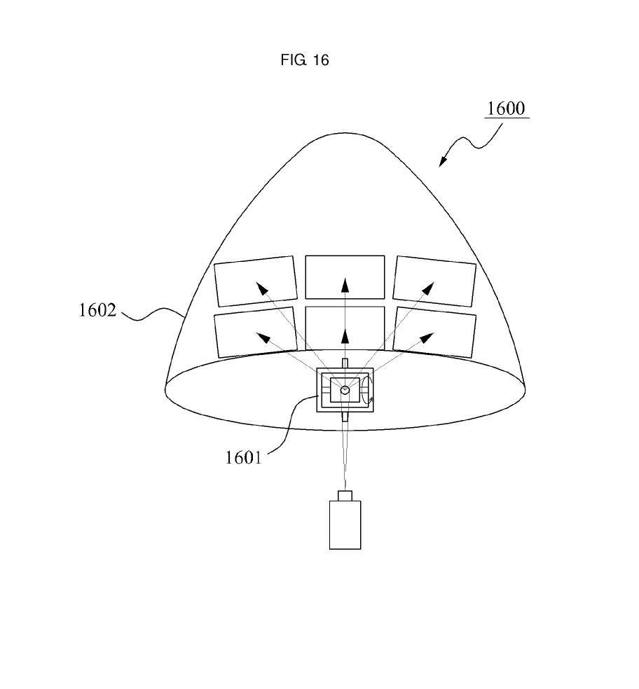

FIG. 16 illustrates a structure of an image display apparatus 1600 including a fixed diffusing screen 1602 provided in a domical shape according to example embodiments.

Referring to FIG. 16, the image display apparatus 1600 may generate a diffusion image, using a two-dimensionally rotating body 1601.

The image display apparatus 1600 may gather light beams included in the diffusion image in a predetermined direction, by adjusting a diffusing angle of the fixed diffusing screen 1602. The image display apparatus 1600 may display, on the fixed diffusion screen 1602, multiview images including the light beams gathered in the predetermined direction.

In this instance, the fixed diffusing screen 1602 may display multiview images representing a vertical view and a horizontal view, simultaneously. Here, the fixed diffusing screen 1602 may have a convex shape in an upper direction, in a lower direction, or in an upper and lower direction.

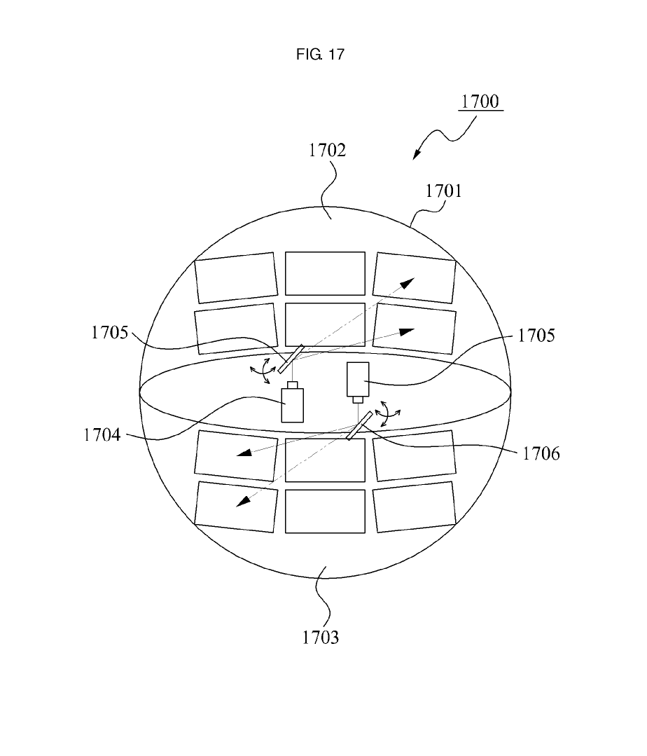

FIG. 17 illustrates a structure of an image display apparatus 1700 including a fixed diffusing screen 1701 provided in a spherical shape according to example embodiments.

Referring to FIG. 17, the image display apparatus 1700 may display multiview images in an upper area 1702 and a lower area 1703 of the screen 1701.

For example, a first light beam outputting unit 1704 may output at least one light beam corresponding to a view image to a first diffusion image generating unit 1705. The first diffusion image generating unit 1705 may generate a diffusion image by diffusing the at least one light beam.

In this instance, the screen 1701 may gather light beams included in the diffusion image in a predetermined direction, by adjusting a diffusing angle. For example, the screen 1701 may gather and distribute the light beams so that multiview images may be displayed at identical view pitches in the upper area 1702 of the screen 1701. Accordingly, the screen 1701 may display the multiview images including the light beams gathered in the predetermined direction in the upper area 1702 of the screen 1701.

Similarly, the image display apparatus 1700 may display multiview images in the lower area 1703 of the screen 1701. For example, the image display apparatus 1700 may display the multiview images in the lower area 1703 of the screen 1701, using a second light beam outputting unit 1705 and a second diffusion image generating unit 1706.

As described above, the image display apparatus 1700 may provide a viewer with multiview images floating like holograms, using the fixed screen 1701 provided in the spherical shape.

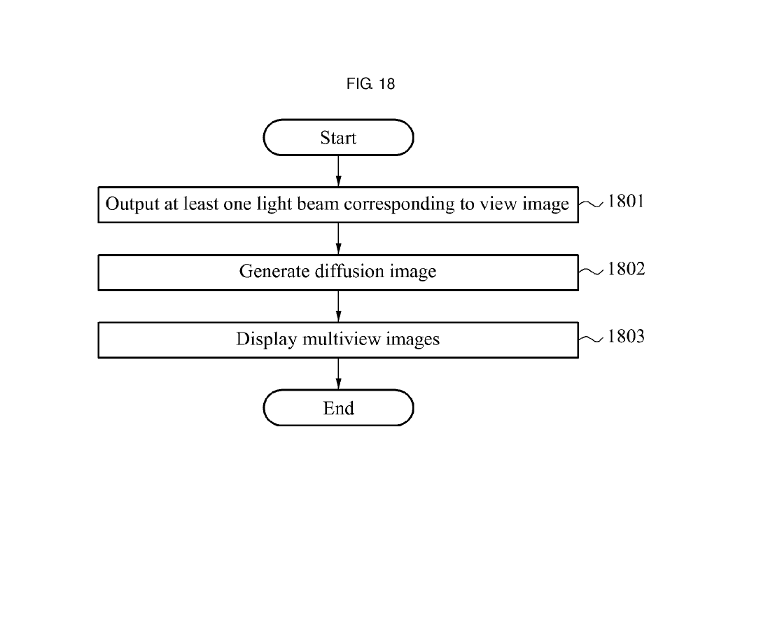

FIG. 18 illustrates a method of displaying multiview images such as a method of displaying the multiview images in the image display apparatus 200 of FIG. 2.

Referring to FIG. 18, in operation 1801, the image display apparatus 200 may output at least one light beam corresponding to a view image.

For example, the image display apparatus 200 may output the at least one light beam, using a projector or an optical module.

In operation 1802, the image display apparatus 200 may generate a diffusion image, by diffuse-projecting the at least one light beam corresponding to the view image in a predetermined direction.

As an example, the image display apparatus 200 may diffuse the at least one light beam in at least one of a horizontal direction, a vertical direction, and a diagonal direction, using a one-dimensionally rotating body.

As another example, the image display apparatus 200 may diffuse the at least one light beam in at least two of the horizontal direction, the vertical direction, and the diagonal direction, using a two-dimensionally rotating body.

Here, the one-dimensionally rotating body or the two-dimensionally rotating body may include a rotating body having a reflective surface, for example, a polygonal mirror, a torsional device, a tilting device, a rotating device, and the like, a rotating body having a diffusion function corresponding to a reflection, for example, a refraction, a diffraction, and the like, and a rotating body having a transmission function.

In operation 1803, the image display apparatus 200 may display, on a screen, multiview images generated when light beams included in the diffusion image area are distributed.

In this instance, the image display apparatus 200 may gather the light beams included in the diffusion image in a predetermined direction, and distribute the light beams, using a reflection mirror or a diffusing screen.

For example, when the reflection mirror is used, the image display apparatus 200 may gather the light beams included in the diffusion image in a direction corresponding to each of the multiview images to be displayed on the screen, using the reflection mirror. The image display apparatus 200 may generate the multiview images including the gathered light beams, and may display the multiview images on the screen.

In this instance, the image display apparatus 200 may adjust a view pitch between the multiview images, by adjusting at least one of a diffusing angle of the screen, a curvature of the screen, a curvature of the reflection mirror, and a position of the reflection mirror.

As an example, the image display apparatus 200 may adjust a horizontal view pitch between the multiview images so that the multiview images may be displayed at identical pitches in a horizontal direction on the screen. Similarly, the image display apparatus 200 may adjust a vertical view pitch between the multiview images so that the multiview images may be displayed at identical pitches in a vertical direction on the screen. The image display apparatus 200 may display the multiview images representing the horizontal view and the vertical view on the screen, by adjusting the horizontal view pitch and the vertical view pitch.

The screen may be provided in various shapes, for example, a shape of a curved surface, a shape of a free curved surface, a shape of a planar surface, a polygonal shape, and the like. In addition, the reflection mirror may be provided in various shapes, for example, a shape of a curved surface, a polygonal shape, a shape of a free curved surface, a shape of a planar surface, and the like.

The method according to the above-described embodiments may be recorded in non-transitory computer-readable media including program instructions to implement various operations embodied by a computer or a processor. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Any one or more of the software modules described herein may be executed by a controller such as a dedicated processor unique to that unit or by a processor common to one or more of the modules. The described methods may be executed on a general purpose computer or processor or may be executed on a particular machine such as the image display apparatuses described herein.

Although embodiments have been shown and described, it would be appreciated by those skilled in the art that changes may be made in these embodiments without departing from the principles and spirit of the disclosure, the scope of which is defined by the claims and their equivalents. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. An image display apparatus, comprising:
a light beam outputting unit to output at least one light beam corresponding to a view image;
a diffusion image generating unit to generate a diffusion image by diffuse-projecting the at least one light beam in a predetermined direction; and
a multiview image generating unit to distribute light beams included in the diffusion image into light beams included in a plurality of multiview images and to display, on a screen, the multiview images.

2. The image display apparatus of claim 1, wherein the multiview image generating unit gathers light beams included in the diffusion image in a predetermined direction corresponding to each of the multiview images, using a reflection mirror, and generates multiview images including the light beams gathered in the predetermined direction.

3. The image display apparatus of claim 2, wherein the reflection mirror adjusts a spatial position pitch between the multiview images to display the multiview images at predetermined view pitches on the screen.

4. The image display apparatus of claim 1, wherein the multiview image generating unit adjusts a view pitch between the multiview images, by adjusting at least one of a diffusing angle of the screen, a curvature of the screen, a curvature of a reflection mirror, and a position of a reflection mirror.

5. The image display apparatus of claim 4, wherein the multiview image generating unit displays multiview images by adjusting the view pitch, and
wherein the multiview images represent at least one of a horizontal view and a vertical view.

6. The image display apparatus of claim 1, wherein the screen comprises a transmissive diffusing screen or a reflective diffusing screen maintaining a diffusing angle of the light beams included in the diffusion image to be a constant.

7. The image display apparatus of claim 1, wherein the diffusion image generating unit diffuses the at least one light beam in at least one of a horizontal direction, a vertical direction, and a diagonal direction, using a one-dimensionally rotating body or a two-dimensionally rotating body.

8. The image display apparatus of claim 1, wherein the multiview image generating unit generates super multiview images, by adjusting a time division interval of the multiview images, and a speed of the at least one light beam to be diffuse-projected, and by increasing a number of views of the multiview images.

9. The image display apparatus of claim 1, wherein the screen comprises a rotary screen provided in a shape of a curved surface, a free curved surface, or a planar surface, and a fixed screen provided in a shape of a sphere, a hemisphere, an ellipse, or a dome.

10. An image display apparatus, comprising:
a light beam outputting unit to output at least one light beam corresponding to a view image;
a diffusion image generating unit to generate a diffusion image by diffuse-projecting the at least one light beam in a predetermined direction;
an optical unit to gather light beams included in the diffusion image; and
a multiview image generating unit to generate multiview images by distributing the light beams gathered by the optical unit.

11. The image display apparatus of claim 10, wherein the optical unit comprises at least one of a reflection mirror and a diffusing screen.

12. The image display apparatus of claim 11, wherein the multiview image generating unit adjusts a view pitch between the multiview images, by adjusting at least one of a diffusing angle of the diffusing screen, a curvature of the diffusing screen, a curvature of the reflection mirror, and a position of the reflection mirror.

13. The image display apparatus of claim 10, wherein the multiview image generating unit adjusts a time division interval of the multiview images by adjusting a switching speed of a spatial light modulator, and increases a number of views of the multiview images by adjusting a speed of the at least one light beam to be diffuse-projected.

14. An image display method, comprising:
outputting at least one light beam corresponding to a view image;
generating a diffusion image by diffuse-projecting the at least one light beam in a predetermined direction; and
displaying, on a screen, multiview images generated when light beams included in the diffusion image are distributed.

15. The image display method of claim 14, wherein the displaying comprises:
gathering light beams included in the diffusion image in a predetermined direction corresponding to each of the multiview images, using a reflection mirror; and
generating multiview images including the light beams gathered in the predetermined direction.

16. The image display method of claim 15, wherein the displaying comprises adjusting a view pitch between the multiview images, by adjusting at least one of a diffusing angle of the screen, a curvature of the screen, a curvature of the reflection mirror, and a position of the reflection mirror.

17. The image display method of claim 16, wherein the displaying comprises displaying multiview images by adjusting the view pitch, and
wherein the multiview images represent at least one of a horizontal view and a vertical view.

18. The image display method of claim 14, wherein the screen comprises a transmissive diffusing screen or a reflective diffusing screen maintaining a diffusing angle of the light beams included in the diffusion image to be constant.

19. The image display method of claim 14, wherein the generating comprises diffusing the at least one light beam in at least one of a horizontal direction, a vertical direction, and a diagonal direction, using a one-dimensionally rotating body or a two-dimensionally rotating body.

20. The image display method of claim 14, wherein the displaying comprises generating super multiview images, by adjusting a time division interval of the multiview images, and a speed of the at least one light beam to be diffuse-projected, and increasing a number of views of the multiview images.

21. An image display method comprising:
generating a diffusion image by diffuse-projecting a plurality of received light beams in a predetermined direction using a rotating body; and
displaying a plurality of multiview images by distributing light included in the diffusion image.

22. An image display apparatus comprising:
a diffusion image generating unit to generate a diffusion image by diffuse-projecting a plurality of received light beams in a predetermined direction using a rotating body; and
a multiview image generating unit to display a plurality of multiview images by distributing light included in the diffusion image.

23. An image display method comprising:
generating a diffusion image by diffuse-projecting a plurality of received light beams in a predetermined direction using a rotating body;
generating a plurality of multiview images by distributing light included in the diffusion image;
displaying the plurality of generated multiview images on a screen; and
adjusting a view pitch between the plurality of displayed multiview images by adjusting at least one of a diffusing angle of the screen and a curvature of the screen.
